(19) United States
(12) Patent Application Publication
(10) Pub. No.: US 2016/0029816 A1
(43) Pub. Date: Feb. 4, 2016

(54) METHODS AND APPARATUS FOR A PRODUCT DISPLAY SYSTEM

(71) Applicant: Steve J. Johns, Paradise Valley, AZ (US)

(72) Inventor: Steve J. Johns, Paradise Valley, AZ (US)

(21) Appl. No.: 14/643,973

(22) Filed: Mar. 10, 2015

Related U.S. Application Data
(60) Provisional application No. 61/950,667, filed on Mar. 10, 2014.

(51) Int. Cl. A47F 5/08; A47F 5/00; A47F 5/01; F16M 13/02

(52) U.S. Cl. CPC A47F 5/0884; F16M 13/022; A47F 5/0093; A47F 5/01; A47F 5/0807; A47F 5/0869

(57) ABSTRACT

Methods and apparatus for a product display system according to various aspects of the present technology may incorporate a shelving system or receiving device comprising a keyed product receiving interface and a conforming product index feature integrated into a product. The conforming product index feature may allow the product to be positioned within or otherwise displayed by a product display device while preventing products without the conforming product index feature from being positioned within or otherwise displayed by a product display device.

### CROSS-REFERENCES TO RELATED APPLICATIONS

This application claims the benefit of U.S. Provisional Patent Application No. 61/950,667, filed Mar. 10, 2014, and incorporates the disclosure of the application by reference.

### BACKGROUND OF INVENTION

Display cases, racks, shelves, and refrigerators are commonly designed to allow a wide variety of products to be displayed. In retail establishments, some display devices have been modified to include markings and labels associated with a particular brand of goods. For example, refrigerated beverage containers may include stickers, lighted display elements, or integrated designs directed towards a single brand. However, once the beverage container is positioned within a retail establishment there is nothing to prevent the beverage container from being used to display beverages that are not associated with the identified brand. Further, the products displayed in the beverage container may include directly competitive products.

### SUMMARY OF THE INVENTION

Methods and apparatus for a product display system according to various aspects of the present technology may incorporate a shelving system or receiving device comprising a keyed product receiving interface and a conforming product index feature integrated into a product. The conforming product index feature may allow the product to be positioned within or otherwise displayed by a product display device while preventing products without the conforming product index feature from being positioned within or otherwise displayed by a product display device.

### BRIEF DESCRIPTION OF THE DRAWINGS

A more complete understanding of the present invention may be derived by referring to the detailed description when considered in connection with the following illustrative figures. In the following figures, like reference numbers refer to similar elements and steps throughout the figures.

FIG. 1 representatively illustrates a front view of a container and a product overlay in accordance with an exemplary embodiment of the present technology;

FIG. 2 representatively illustrates a side view of the container and the product overlay of FIG. 1 hanging from a display fixture in accordance with an exemplary embodiment of the present technology;

FIG. 3 representatively illustrates a perspective view of the display fixture in accordance with an exemplary embodiment of the present technology;

FIG. 4 representatively illustrates an exploded view of the product overlay and the container in accordance with an exemplary embodiment of the present technology;

FIG. 5 representatively illustrates the product overlay coupled to the container in accordance with an exemplary embodiment of the present technology;

FIG. 6 representatively illustrates the product overlay coupled to a body section of the container in accordance with an exemplary embodiment of the present technology;

FIG. 7 representatively illustrates the product overlay coupled to a neck portion of the container in accordance with an exemplary embodiment of the present technology;

FIGS. 8A-8D representatively illustrate a display fixture and an exemplary indexing fixture in accordance with an exemplary embodiment of the present technology; and

FIG. 9 representatively illustrates a product overlay that folds over and adheres to a container in accordance with an exemplary embodiment of the present technology.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various types of stands, display devices, shelving systems, containers, and the like, which may carry out a variety of functions. Further, the present technology may employ any number of conventional techniques for displaying products, providing consistent product placement, and/or positioning products at point-of-sale locations.

Methods and apparatus for measuring properties for a product display system according to various aspects of the present technology may operate in conjunction with any suitable product or product display system. Various representative implementations of the present invention may be applied to any type of consumer product and any type of surface where the display may be mounted or may otherwise be placed and/or maintained. The product may comprise any suitable device and/or type of container such as: a plastic, glass, or metallic beverage container, bag, box, and the like. Various embodiments of the present technology may provide multiple approaches to ensuring that only a specific product may be displayed in a predetermined and specific location. One such approach may comprise modification of the shape of the product or product container and/or by providing a product overlay that contains unique display characteristics allowing it to mate to a predefined dispensing mechanism. It is to be understood that the present invention may not be limited to food, beverage, pharmaceutical or durable goods and/or the product examples displayed within this application, but may be applied to virtually any product or application. While the invention may be susceptible to various modifications and alternative forms, specific embodiments thereof are shown by way of example in the drawings and may herein be described in detail.

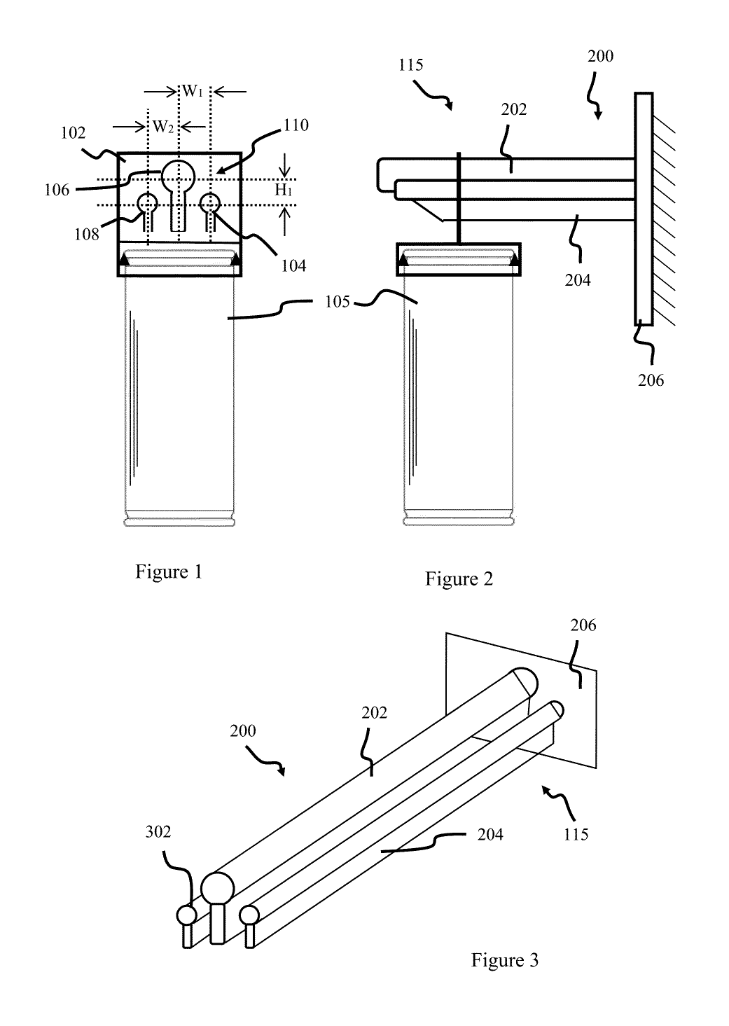

Referring now to FIGS. 1-3, in one embodiment, a keyed product display system, or product interlock system may comprise a hanger system comprising a display fixture 115 configured to hold, attach, secure, or otherwise receive a container 105. The display fixture 115 may comprise one or more receiving interfaces 200 that are suitably configured to engage a mating set of product indexing features 110 formed in a product overlay 102 that is integrated into or otherwise coupled to the container 105.

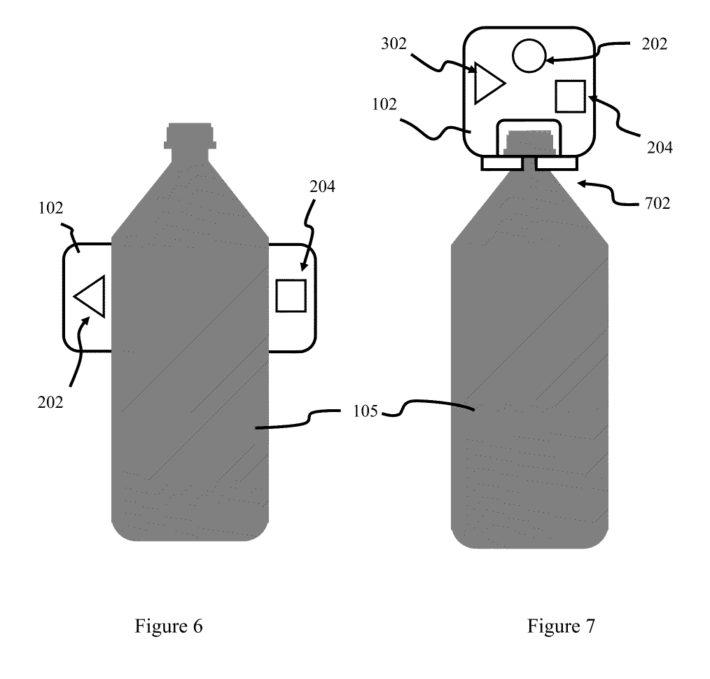

The product hanger system may be configured such that the container 105 hangs from the display fixture 115. For example, the receiving interfaces 200 may comprise one or more keyed protrusions 202, 204, 302 that extend outward from a base 206 of the display fixture 115. Each keyed protrusion 202, 204, 302 may comprise a predetermined size and/or geometric shape that provides a unique mate to receive a corresponding indexing feature 110 on the container 105. Accordingly, the design, shape, size, and/or orientation of the keyed protrusions 202, 204, 302 may create a unique pattern specific only to the indexing feature 110 formed in a product overlay 102 coupled to the container 105. Referring now to FIGS. 6 and 7, to further enhance the potential number of different combinations, multiple shapes may be incorporated into the keyed protrusions 202, 204, 302 such as, but not limited to, round, square, hexagonal, octagonal, triangular, etc.

In some embodiments, the base 206 of the display fixture 115 may be configured to be coupled to a fixed surface, such as a wall, a refrigeration unit, a floor or table stand, or any other suitable device for supporting the product interlock system at a point-of-sale. In some embodiments, the display fixture 115 itself may be attached to a vertical surface, a horizontal surface, and/or any combination thereof. The display fixture 115 may be configured to be angled when gravity assisted feeding of the product container 105 onto the display fixture 115 may be efficacious.

The product indexing features 110 of the product overlay 102 may comprise a set of openings configured to fit around the receiving interfaces 200 of the display fixture. Referring again to FIG. 1, in one embodiment, the product overlay 102 may comprise three openings 104, 106, 108 that are suitably configured to allow the keyed protrusions 202, 204, 302 to pass through. As a result, if product indexing features 110 of the product overlay 102 correspond to the receiving interfaces 200, then the container 105 may hang from the display fixture 115. Conversely, if the container 105 does not have a set of corresponding product indexing features 110 that match the receiving interfaces 200, then the container 105 may not be able to hang from the display fixture 115. Additionally, in some embodiments, the product indexing features 110 may conform to the keyed receiving intervaces 200 in an orientation that maintains a pre-selected face of the container 105 facing outward toward the consumer or end-user in the display fixture. For example, the pre-selected face of the container 105 may show a front label bearing the brand or product name of the container 105 to attract the consumer or end-user to take and purchase the container 105.

The receiving interfaces 200 may also be positioned or oriented on the base 206 according to any predetermined criteria. For example, with continued reference to FIGS. 1 and 3, a first opening 104 may be separated from a second opening 106 by a first horizontal distance W₁ and a third opening 108 may be separated from the second opening 106 by a second horizontal distance W₂. The distance between each opening may allow for a wide variety of indexing distances that may allow a large number of combinations. Similarly, the first opening 104 may be separated from the second opening 106 by a vertical distance H₁ that may be varied to create a variety of combinations.

Similarly, receiving interfaces 200 of the display fixture 115 may be rotated by any suitable degree from a vertical or horizontal position to provide an even a greater number of combinations. Alternatively, each receiving interface 200 may comprise a different in size and/or shape. For example, a first keyed protrusion 202 may comprise a substantially similar shape or design as a second keyed protrusion 204, but be larger in scale. Accordingly, by combining the varying horizontal and vertical distances, a collection of unique keyed combinations of receiving interfaces 200 and product indexing features 110 may be created. As a result, each product bearing the product overlay 102 may hang from the display fixture 115 while other products are prevented from being hung from the display fixture 115.

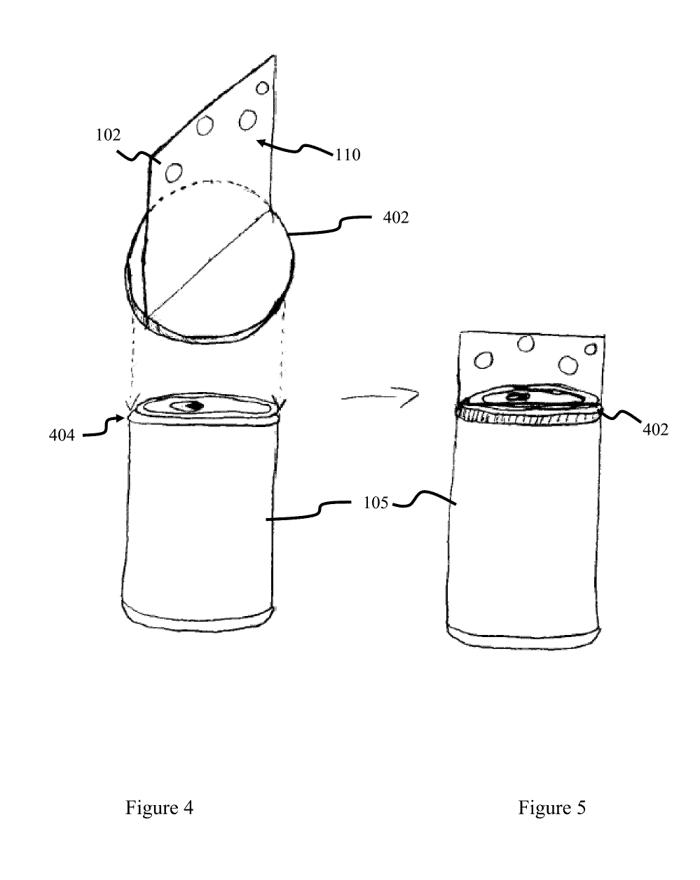

Referring now to FIGS. 4 and 5, the overlay 102 may comprise a separate device and/or the overlay 102 may comprise a modification to the product container 105. In one embodiment, the overlay 102 may be coupled to an upper portion 404 of the container 105 to create a package that may only be displayed when mated to the corresponding portion of the display fixture 115. For example, the product overlay 102 may comprise a ring 402 suitably configured to be positioned around the upper portion 404 of the container 105.

The product overlay 102 may be comprised of, but not limited to: shrink-wrap, paper, paperboard, cardboard, plastic, metal, fiber, wood, and/or other materials suitable to provide the mechanical qualities required to support and provide proper indexing of the container 105 to the point-of-sale display mechanism. In some embodiments, the product overlay 102 may comprise one or more removal features that may assist in the removal of the overlay 102 from the container 105. This feature may comprise, but is not limited to, a predefined pull-tab, pre-cut path, tear-way path, perforation or the like to assist in this function after the product is removed from the point-of-sale location. In one embodiment, the product overlay 102 may cover a drinking spout on the container 105, maintaining a sanitary area for drinking that may be uncovered by removal of the product overlay 102, such as by using the removal feature.

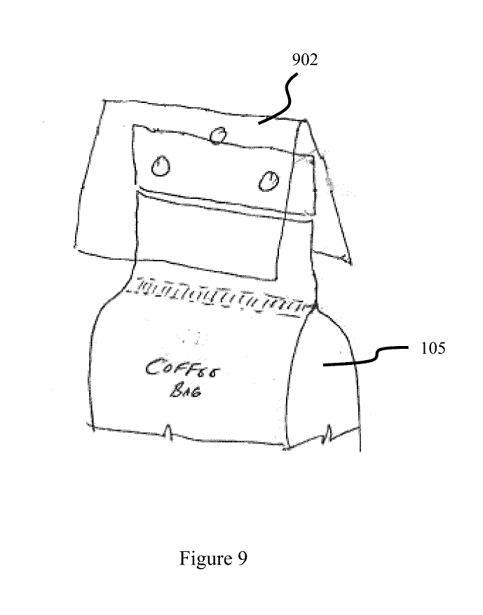

Referring again to FIG. 6, the product overlay 102 may be coupled to a portion of the body of the container 105. For example, the product overlay 102 may be a tab or other fitting applied to the container 105, such as a tab on a shrink-wrap covering the container 105. In various embodiments, the product overlay 102 may be directly attached, affixed, glued, welded, molded or otherwise directly attached in a permanent or semi-permanent (removable by the end-user) fashion to the container 105 itself. For example, referring now to FIG. 9, in one embodiment, the product interlock system may comprise a product container overlay 902 that may be a flexible material comprising an adhesive that may fold over and adhere to the product container 105.

Referring again to FIG. 7, in another embodiment, the container 105 may comprise a two-liter beverage bottle and the product overlay 102 may be a plastic, metal, or other material that snaps over the neck feature 702 inherent and commonly found on bottles of this type. Alternatively, the neck feature 702 of the container 105 may be modified to readily accept the indexing product overlay 102. For example, by making the neck feature 702 octagonal, square or other non-round shape, the product overlay 102 may be limited to being applied in a specific way ensuring the product label of the container 105 is maintained facing outward toward the consumer or end-user. In yet another embodiment, the product overlay 102 and a cap of the container may be integrally formed into a single unit. This may provide the added benefit of providing a larger area to grip which greatly increases the torque the end-user may apply when removing the cap. In some embodiments, the product overlay 102 may comprise a shape for improved leverage to open the container 105, such as a rod or “mouse ear” shape for easy twisting.

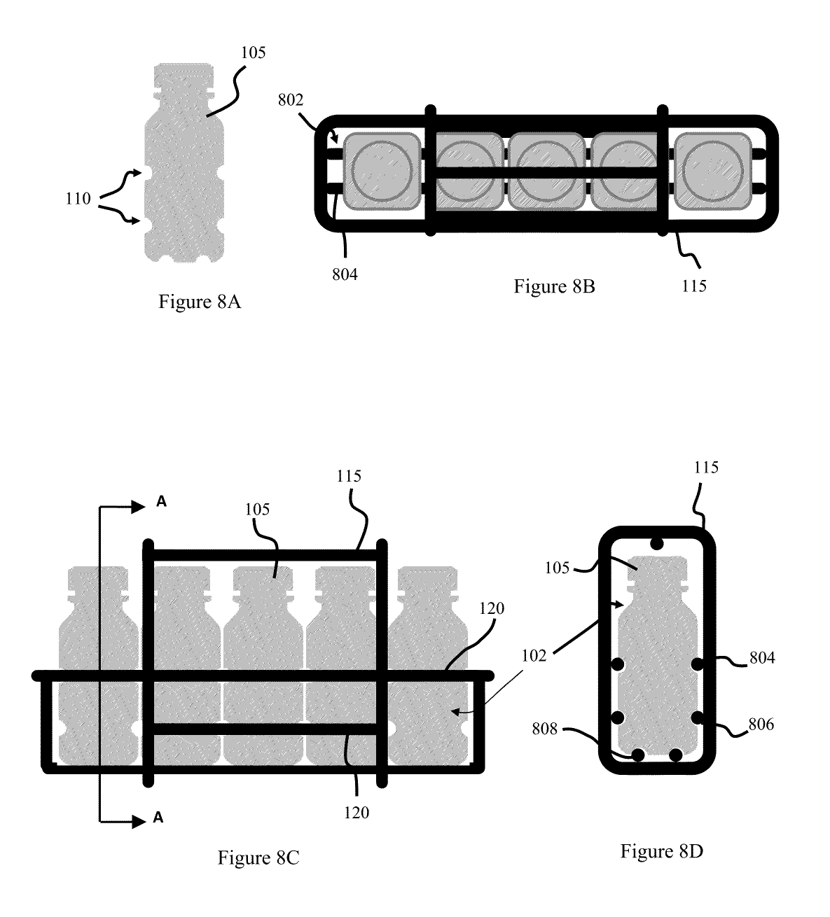

Referring now to FIGS. 8A-8D, the display fixture 115 may form a keyed receiving system for receiving a product having a design feature configured to mate to the keyed receiving system. The display fixture 115 may comprise any suitable device or system for receiving a product such as: a shelving system, a hanger system, a product display container, and the like. The display fixture 115 may be made of any suitable material, including, but not limited to metal, wire, plastic, wood, paper, cardboard, or any other suitable material. The size of the display fixture 115 may correspond to the dimensions of the corresponding container 105.

The overall length may be varied to meet the needs of the wholesaler, distributor, and/or retailer and to match the depth of the display/dispensing unit and/or available existing racking. For example, in one embodiment, the display fixture 115 may comprise rack system having a receiving area 802 comprising a length and/or depth suitable to hold multiple containers 105 in a front-to-rear or rear-to-front stocking system such as commonly used in refrigerated sections of a retail store or as found in a refrigerated standalone display case. The receiving area 802 of the display fixture 115 may comprise one or more keyed receiving interfaces 804 that are suitably configured to project into the receiving area 802. For example, in one embodiment, a single keyed receiving interface 804 may comprise a rail extending at least part way along the length or depth of the display fixture 115. The rail may project outwardly from a surface of the display fixture 115 into the receiving area 802 to act as an impediment or barrier to a non-keyed container. The display fixture 115 may comprise additional rails 806, 808 positioned at any additional desired locations along the receiving area 802 to form a unique interlock system for preventing non-keyed containers from being positioned in the receiving area 802.

The product indexing feature 110 may be integrally designed into a product or the product's container 105 and may comprise a unique design feature, such as a notch or other shaped indentation or pattern of indentations, which may function as a “lock.” The product indexing feature 110 may be mated to the keyed receiving interface 804, the “key,” that may be integrated into display fixture 115.

Referring now to FIG. 8A, in one embodiment, the container 105 may be modified to create one or more unique indexing characteristic models—similar to the tumblers in a lock that require a unique set of corresponding teeth provided by the mating key. In this embodiment, six product indexing features 110, two on each side and two on the bottom, maybe used to mate to corresponding keyed receiving interfaces 804 on the display fixture 115. The number or the positioning of the product indexing features 110 on the container 105 may be determined according to any suitable criteria such as: the space and volume present of the container 105, a general shape and/or footprint of the container 105, or the like.

Referring now to FIG. 8D, a possible combination of one or more product index features 110 that may be used. Not all product index features 110 are required and it is assumed that different containers 105 could be assigned and would contain specific product index codes. For example, in one embodiment, a popular soft drink manufacturer could be assigned a product container 105 profile that uses only two of the six keyed receiving interfaces 804, 806, 808 shown. In another embodiment, a manufacturer of a beer may be assigned an at least partially different code combination which may restrict their product containers 105 from being mixed and displayed in the beer manufacturer's coolers with non-alcoholic beverages. In another embodiment, an energy drink manufacturer may use the combination of product index features 110 at the bottom of their container 105. This differentiation of locks and keys between each product container 105 may eliminate competitive products from being jointly displayed in refrigeration units the manufacturer provides to their end-point of sale retailers.

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. A keyed product display system for a container, comprising:
a display fixture comprising a keyed receiving interface; and
a product index feature integrated with the container, wherein the product index feature conforms to the keyed receiving interface to allow the container to be selectively secured to the display fixture.

2. A keyed product display system according to claim 1, wherein the display fixture comprises a mounting bracket.

3. A keyed product display system according to claim 1, wherein the product index feature conforms to the keyed receiving interface in an orientation that maintains a pre-selected face of the container facing outward.

4. A keyed product display system according to claim 3, wherein the
the keyed receiving interface comprises:
a first protrusion extending outward from first position on a base of the mounting bracket; and
a second protrusion extending outward from a second position on the base of the mounting bracket, wherein the second protrusion is not aligned with the first protrusion along a common vertical or horizontal plane relative to an edge of the mounting bracket; and
the product index feature comprises:
a first opening configured to fit around the first protrusion; and
a second opening configured to fit around the second protrusion.

5. A keyed product display system according to claim 4, wherein the product index feature is configured to be coupled to the container.

6. A keyed product display system according to claim 5, wherein the product index feature comprises a ring configured to connect to an upper lip portion of the container.

7. A keyed product display system according to claim 5, wherein the product index feature further comprises a cover configured to cover at least a top portion of the container.

8. A keyed product display system according to claim 4, wherein:
the first protrusion comprises a first cross-sectional area; and
the second protrusion comprises a second cross-sectional area.

9. A keyed product display system according to claim 8, wherein the second cross-sectional area is smaller than the first cross-sectional area.

10. A keyed product display system according to claim 8, wherein:
the first cross-sectional area comprises a first geometric shape; and
the second cross-sectional area comprises a second geometric shape.

11. A keyed interlock system for displaying a beverage container in a product display device, comprising:
a support bracket coupled to the product display device, wherein the support bracket comprises:
a first protrusion extending outward from a first location on a base of the support bracket towards a front of the product display device; and
a second protrusion extending outward from a second location on the base of the support bracket towards the front of the product display device, wherein the second protrusion is not aligned with the first protrusion along a common vertical or horizontal plane relative to an edge of the support bracket; and
a product index feature configured to be coupled to the beverage container, wherein the product index feature comprises:
a first opening configured to fit around the first protrusion; and
a second opening configured to fit around the second protrusion.

12. A keyed interlock system according to claim 11, wherein the second protrusion comprises a different geometric shape than the first protrusion.

13. A keyed interlock system according to claim 11, wherein the second protrusion comprises a different size than the first protrusion.

14. A keyed interlock system according to claim 11, wherein the product index feature fits around the first protrusion or the second protrusion in an orientation that maintains a pre-selected face of the beverage container facing outward.

15. A keyed interlock system according to claim 11, wherein:
the support bracket further comprises a third protrusion, wherein the third protrusion comprises a different size than at least one of the first and second protrusions; and
the product index feature further comprises a third opening configured to fit around the third protrusion.

16. A keyed interlock system according to claim 15, wherein the third protrusion is not aligned with at least one of the first and second protrusions along a common vertical or horizontal plane relative to the edge of the support bracket.

17. A keyed interlock system according to claim 15, wherein the third protrusion comprises a different geometric shape than at least one of the first and second protrusions.

18. A keyed interlock system according to claim 11, wherein product index feature further comprises a coupler configured to attach to an upper edge portion of the beverage container.

19. A keyed interlock system according to claim 11, wherein product index feature further comprises a covering configured to cover an access location to the beverage container.
